(19) United States
(12) Patent Application Publication
(10) Pub. No.: US 2016/0368527 A1
(43) Pub. Date: Dec. 22, 2016

(54) POWER STEERING SYSTEM WITH SPINDLE DRIVE

(71) Applicant: Thyssenkrupp Presta AG, Eschen (LI)

(72) Inventors: Zoltan STAMM, Gams (CH); Krisztian RATH, Budapest (HU)

(21) Appl. No.: 15/248,941

(22) Filed: Aug. 26, 2016

Related U.S. Application Data
(62) Division of application No. 13/992,161, filed on Jun. 6, 2013.

(30) Foreign Application Priority Data
Dec. 16, 2010 (DE) 102010054828.6

(51) Int. Cl. B62D 5/04; F16H 25/24; F16H 25/22

(52) U.S. Cl. CPC B62D 5/0448; F16H 25/2209; F16H 25/24; F16H 2025/2445

(57) ABSTRACT

A power assisted steering system, in particular for a motor vehicle, may have a servo drive which drives a structural element which can be axially displaced by means of a nut which is rotatably mounted in a bearing in a frame, wherein the nut engages with a threaded spindle which is formed on the structural element and which is elastically supported in an axial direction by means of spring elements relative to the frame and supported in a radial direction along a narrow peripheral contact surface on the frame, wherein the bearing is in abutment with the frame on the outer circumferential surface of the outer ring on the contact surface by means of a web, and in which a plastics material element is provided in the region of the web, which plastics material element prevents direct metallic contact between the bearing and the frame.

This application is a divisional application of U.S. patent application Ser. No. 13/992,161, filed on Jun. 6, 2013 as a U.S. National Stage Application of PCT International Application No. PCT/EP11/06183, filed on Dec. 8, 2011, which claims priority to German Patent Application No. 10 2010 054 828.6, filed on Dec. 16, 2010, all of which are incorporated by reference herein.

The present invention relates to power assisted steering system, in particular for a motor vehicle, having a servo motor which drives a structural element which can be axially displaced by means of a nut rotatably mounted, but not axially displaceable. With steering systems having an electromotive servo drive which works by means of a spherical spindle drive, the spherical nut is either rigidly mounted in the housing or a certain degree of longitudinal and tilting movement is enabled by the use of spring elements and the particular design of the housing. Spherical bearings in which both the bearing ring and the frame have a spherical surface are also known. In this solution, the centre of the spherical surface in the central plane of the bearing is determined based on construction. Similar functions are enabled by spherical roller bearings and self-aligning roller bearings which permit an angle error in the shaft. The aim of this bearing is to compensate for the tolerance, avoiding tensioning in the spherical spindle drive. The dynamic and static load on the components is further reduced. This results in improved acoustic properties and a reduction in the mechanical clearance which arises as a result of thermal expansion of the components.

In the description of bearing between spherical surfaces, just as with the use of spherical roller bearings and self-aligning bearings, the problem arises that this bearing is better designed for radial forces. The stresses which occur on the spherical nut in an electrically supported steering drive, however, are mainly axial in terms of the steering rack or spindle thread.

DE 103 10 492 A 1 describes power assisted steering system, in particular for motor vehicle, having a servo motor formed as an electric motor, which servo motor drives a structural element which is formed as a push rod and can be axially displaced via a nut which is rotatably mounted in a frame formed as a steering system housing, but which is not axially displaceable. The servo motor, the push rod and the nut are mounted by means of an excentric bearing ring such that the axial distance between the motor shaft of the servo motor and the push rod can be varied, which enables simple, rapid assembly of the power assisted steering system.

An electrical steering device is known from DE 102 02 483 A1 which has a steering rack connected to a driving spindle, a motor to support a driving force having a rotor which is arranged coaxially on the steering rack, a spindle drive in which the balls are inserted between a nut wedged with the rotor and a screw formed on the steering rack, and which has a housing which is overall shaped approximately cylindrically. The nut of the recirculating ball spindle mechanism is rotatably mounted in a bearing in the inside of the section of the nut housing.

DE 1947337 U shows an elastic roller bearing which has axial movement and axial suspension with restoring force. A roller bearing having a bearing outer ring and a bearing inner ring, wherein the bearing outer ring and/or the bearing inner ring are each arranged between at least one damping element, is known from DE 10 2004 034 701 A1.

EP 1 571 067 A 1 discloses the elastic bearing of a worm shaft which co-axially encompasses the motor shaft of a servo motor.

The generic EP 2 049 383 81 shows a solution to enable or to improve the pivotability of the radial bearing. It is provided to provide a convex curve on the outer periphery of the outer ring or to provide the nut on which the inner ring sits with a convex curve. The convex curve on the outer edge of the outer ring or the nut should release the radial bearing and achieve a pivotability of the nut and the axially displaceable structural element. A steel ring with a vulcanised element having elastomer properties is provided on each front face of the radial bearing, which should enable axial and radial damping and the implementation and damping of the pivoting movement of the axially displaceable structural element at varying stresses. During bending moment strain on the axially displaceable structural elements, tensioning of the system should be avoided.

In operation, it has been shown that noise and wear occur on the metallic contact surfaces in the region of the outer edge of the spherical nut. Noises also occur on the metallic support for the elastomer damping element.

The object of the invention is to provide a power assisted steering system with a tiltable bearing of the spherical nut having a lower level of noise generation.

This object is achieved by a power assisted steering system having various features as may be found in the attached claims.

Since the bearing abuts the outer circumferential surface of the outer ring by means of a web which is narrow in an axial direction and is provided with a plastics material element in the region of the contact surface or contact line, which plastics material element prevents direct metallic contact between the bearing and the frame, particularly good noise damping can be achieved.

The web can be convex. This design enables a tilting movement of the bearing relative to the frame. In this, it is advantageous if the bearing has a peripheral external groove on its outer ring into which the damping insert is inserted. The damping insert can then cooperate with the web of the frame and reduce the occurrence of noise.

It can also be provided that the peripheral web of the frame is manufactured from a damping, non-metallic material. The web can be inserted as an inserted part into a groove, wherein the groove can pierce the circumferential surface of the bearing seat radially in an outwards direction. The bearing seat itself then has a larger diameter than the outer diameter of the bearing outer ring. Furthermore, axial support of the spherical nut can also be effected by damping elements which are inserted or incorporated into grooves which are provided in the frame and are opposite to the front face of the bearing outer ring in an axial direction.

It is advantageous if the damping element with elastomer properties is provided with a shape-retaining element which lies in the bearing outside of the force flux. This means that a particularly light embodiment of the component can be selected. In particular, the shape-retaining element may also be manufactured from plastics material. The damping element abuts the surfaces of the steering system housing which can move relative to one another in an axial direction on the one hand and on the bearing on the other. A metallic installation in the force flux, which could lead to the production of noise during operation, is avoided in this way.

The shape-retaining part may be a concentric ring which is arranged on the inside of the damping element. This embodiment also provides a cost advantage in addition to saving weight. If there is a load on the damping element caused by axial compression, it is advantageous if the support element is axially displaceable in the frame. This means that the connection between the damping element and the support element is kept free of disadvantageous strains in a shear direction.

Exemplary embodiments of the present invention are described below on the basis of the diagrams, whereby:

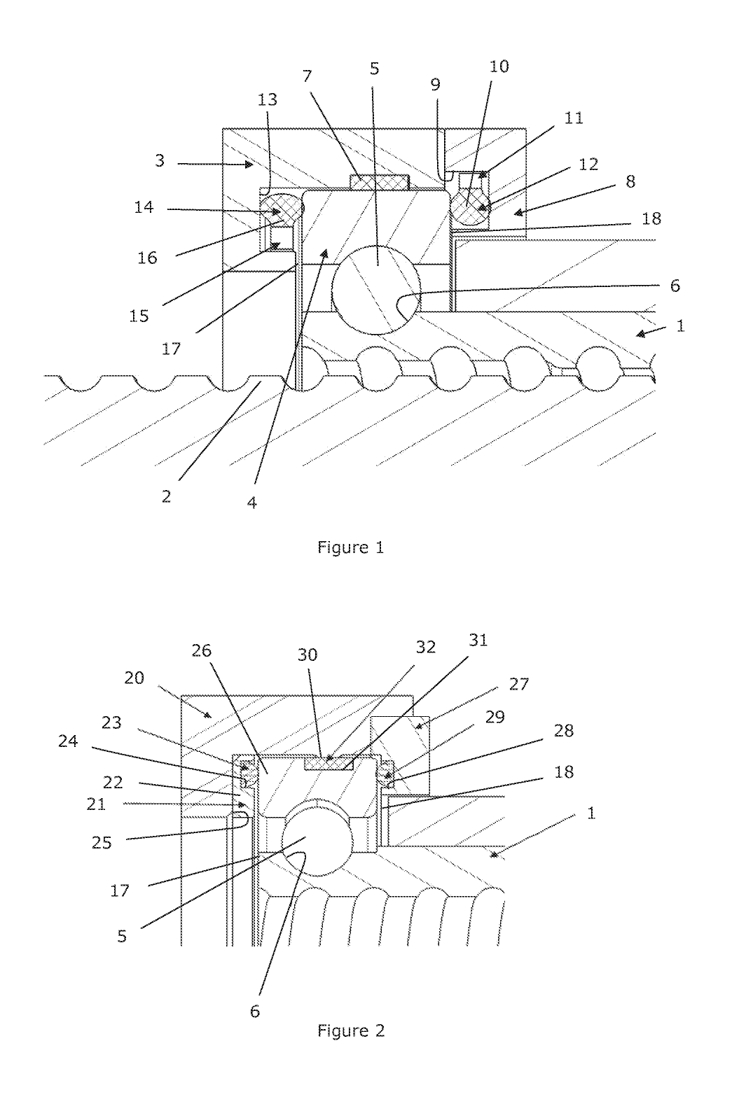

FIG. 1 shows a first exemplary embodiment of the invention;

FIG. 2 shows a second exemplary embodiment of the invention with a damping element on the periphery side;

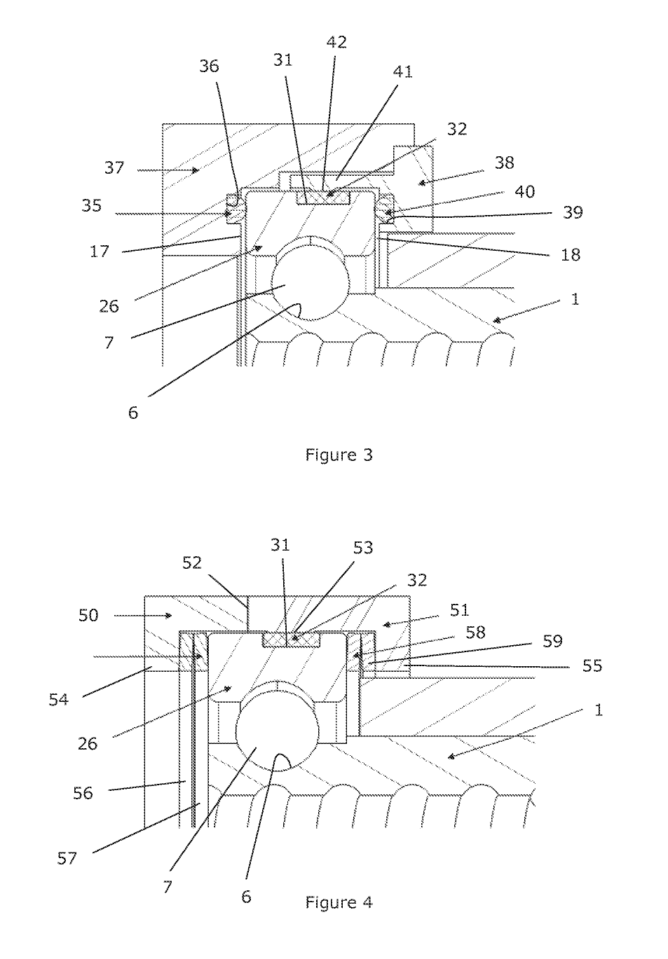

FIG. 3 shows a variant of the embodiment in accordance with FIG. 2;

FIG. 4 shows a third embodiment of the invention with plate springs for axial suspension;

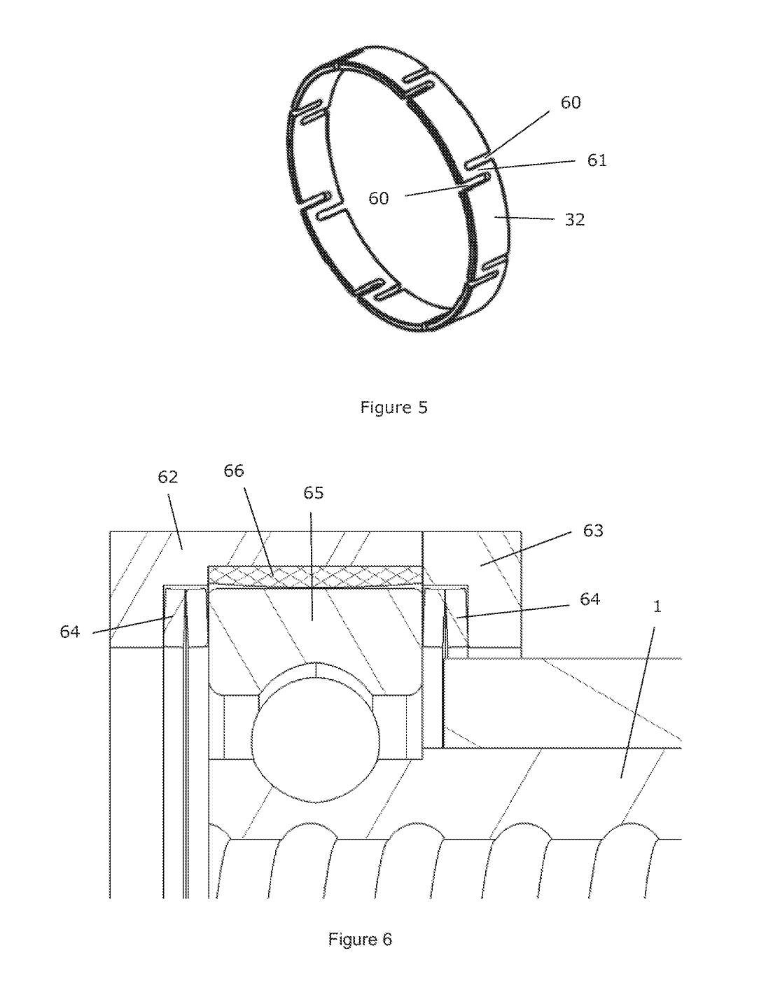

FIG. 5 is a perspective view of the damping element from FIGS. 1 to 4

FIG. 6 is an alteration of the embodiment in accordance with FIG. 4 with a convex damping element on the periphery side; and

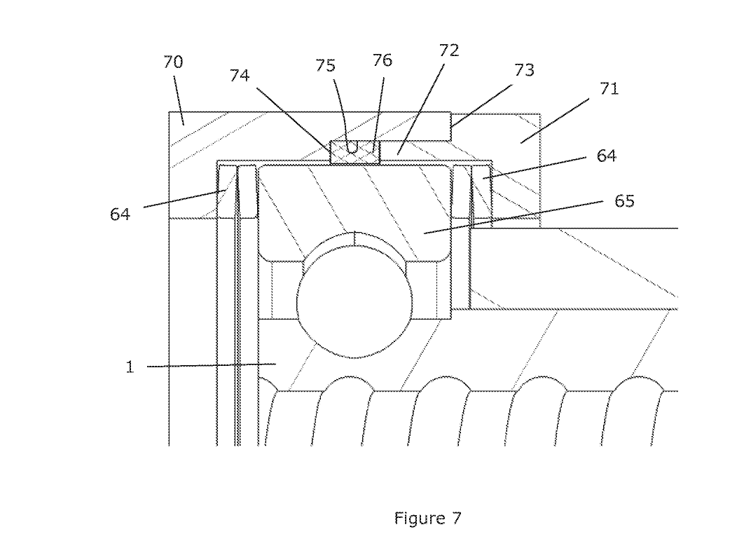

FIG. 7 shows a variant with a damping element which is easy to assemble.

FIG. 1 is a schematic longitudinal section through a steering gear in the region of the bearing of a spherical nut 1. The spherical nut 1 encloses a threaded spindle 2 and engages with the threaded spindle 2 such that a rotation of the spherical nut 1 displaces the threaded spindle 2 in an axial direction relative to a frame 3, which is part of a steering system housing (not shown). The spherical nut 1 can additionally be driven by an electric motor, for example, by a toothed belt (not shown). The bearing of the spherical nut 1 relative to the frame 3 is carried out in a ball bearing having an outer ring 4, spherical roller element 5 and an inner running surface 6 which is formed directly on the spherical nut 1, which makes the arrangement of the bearing particularly compact. Instead of this particularly compact embodiment, a standard roller bearing can also be used in this position.

The bearing of the outer ring 4 in the frame 3 is carried out in a radial direction such that the frame 3 is provided with a web 7 in the region of the bearing seat, which web is arranged continuously and abuts the bearing outer ring 4 along a circular area with a low clearance. The clearance is preferably designed as a sliding seat such that the bearing outer ring 4 can be displaced in an axial direction with a low level of force, wherein the external circumferential surface of the outer ring 4 then glides on the inner circumferential surface of the web 7.

The bearing outer ring 4 is secured in its bearing seat in the frame 3 by a protective element 8, which for example may be a ring nut. The protective element 8 has a groove 9 facing the bearing outer ring 4 with a rectangular cross section. The groove flanks are cylindrical, peripheral surfaces which are arranged coaxial to the arrangement while the bottom of the groove is a circular area which extends parallel to the planar front face of the bearing outer ring 4. A damping element 10 which has a spring and damping effect is inserted between the bearing outer ring 4 and the bottom of the groove. The damping element 10 has a circular support 11 and a damping element 12 which is also circular, and which is fixed inside on the support 11. The damping element 12 is thicker than the support 11 in the axial direction of the arrangement. One side of the damping element 12 abuts the adjacent front face of the bearing outer ring 4. The other side abuts the bottom of the groove 9.

Accordingly, the opposite side of the frame 3 is provided with a groove 13 which also has a rectangular cross section and which is open in an axial direction of the arrangement as far as the bearing outer ring 4. A damping element 14 lies in the groove 13, which damping element includes an inner fixed support 15 and an outer damping part 16. The damping part is attached externally on the support 15. The damping part 16 is thicker than the support 15 in an axial direction of the arrangement, and one side of it abuts the bearing outer ring 4 while the other side abuts the bottom of the groove 13. The bearing outer ring 4 is further mounted in the frame 3 such that a gap 17 or 18 remains on both sides of the front face of the bearing outer ring 4 and the bearing outer ring 4 sits movably within the frame 3 about the clearance in an axial direction.

When loads occur which affects the bearing of spherical nut 1, the bearing outer ring 4 can move away to a limited extent, so the spherical nut is correspondingly movable and slight deflections or sudden loads on the steering rack 2 can occur without the bearing or the ball circuit being itself damaged in. In this process, the web 7 enables a tilting of the bearing outer ring 4 when radial deflections of the steering rack 2 occur.

The damping elements 10 and 14 are particularly advantageous in this embodiment as on the one hand they can be manufactured inexpensively as the supports 11 or 15 can be manufactured from a fixed, dimensionally stable plastics material, while the damping parts 12 or 16 can be manufactured from an elastomer material. The connection between the two named elements of the damping element does not experience particularly high strain as the supports 11 or 15 do not lie in the force flux when the bearing outer ring 4 is moved. Furthermore, the clearance of the gaps 17 and 18 limits the movement of the bearing outer ring 4 such that even the actual damping body cannot be compromised and loaded beyond a constructively predetermined level. For assembly, it is advantageous that the damping elements 10 and 14 can easily be inserted into the grooves 9 and 13 during assembly without special devices being required for this.

This results in a good value, permanent and easy to assemble solution and particularly low-noise operation is achieved because the damping elements do not have any metallic support elements in the force flux.

FIG. 2 shows another embodiment of the invention in a representation in accordance with FIG. 1. Like components are provided with like reference numbers. No steering racks are shown in this representation.

A compact method of construction of a frame 20 is possible in that a damping element 21 is provided with a circular support 22 and a damping part 23, wherein the support 22 bears a circular peripheral groove which is open towards a planar side, into which groove the damping element is incorporated. The damping part 23 itself is made out of an elastomer while the support 22 can be manufactured from a tough plastics material or metal. The frame 20 has a circular peripheral collar 25 which the damping element 21 abuts with its planar side facing away from the groove 24. A bearing outer ring 26 abuts the damping part 23 with its planar side. The opposite planar side of the bearing outer ring 26 is secured by a protective element 27, also shown here in the form of a ring nut. As with the protective element 8 from FIG. 1, the protective element 27 has a groove facing the bearing outer ring 26, the bottom of which extends parallel to the adjacent flat side of the bearing outer ring 26. A circular damping element 29 is inserted or shaped into the groove 28. This abuts the planar front face of the bearing outer ring 26 with its free side facing away from the bottom of the groove. In turn, the frame 20 has a web 30 which guides the bearing outer ring 26 in a radial direction. The bearing outer ring 26 is provided with a groove 31 in the region abutting the web 30. The groove extends in the circumferential direction of the bearing outer ring 26 on the outer side thereof. A damping element 32 is inserted into the groove 31, which damping element is arranged in abutment with the web 30.

In the embodiment in accordance with FIG. 2, it is possible to inject the peripheral circular damping parts 23 and 29 into the grooves 24 and 28. An EPDM or HNBR material could be used for this for example. Construction is possible in a more compact manner than in the embodiment in accordance with FIG. 1. A compression of the damping parts 23 and 29 is also limited in this embodiment by the shape of the gaps 17 and 18 which limit the axial movement of the bearing outer ring 26 before the damping parts can be damaged.

The circular damping element 32 can also be made from a plastics material, wherein a relatively hard plastics material is preferred which will produce a favourable friction combination with the web 30. In contrast to the embodiment in accordance with FIG. 1, in this embodiment the bearing outer ring 26 is not in direct metallic contact with the frame 20, so improved sound damping is achieved.

FIG. 3 shows a simple variant of the embodiment in accordance with FIG. 2. In this variant, a damping element 35 is inserted directly into a peripheral groove 36 of a frame 37, for example injected in. The bearing outer ring 26 is provided with the peripheral outer groove 31 as in FIG. 2, in which groove the damping element 32 lies. A protective element 38 is provided here as a bolted bushing. The protective element 38 has a groove 39 facing the bearing outer ring 26 and a damping element 40 arranged in the groove 39, as in FIG. 2. The damping elements 35 and 40 abut the two flat front faces of the bearing outer ring 26. The protective element 38 has a sleeve-like extension 41 which surrounds the bearing outer ring 26 and whose inner diameter is larger than the outer diameter of the bearing outer ring 26. The sleeve-like extension 41 has a web 42 on its inner side, which web is in abutment with the damping element 32 in the assembly position shown, specifically which approximately centrally abuts the outer surface thereof along the periphery. The entire arrangement is approximately rotationally symmetrical to the central axis of the spherical nut 1.

In this embodiment, the number of structural elements is decreased still further as the damping element 35 is arranged directly in the frame 37. The bearing outer ring 26 is movable to a limited extent as in the other exemplary embodiments. When movement occurs in an axial direction, the damping element 32 slides on the inner surface of the web 42 while the damping elements 35 and 40 are compromised depending on the direction of movement. Due to the relatively short extension of the web 42 in an axial direction, the bearing outer ring 26 can also tilt to a small extent without this causing any damage. The deformation of the damping elements 35 and 40 is in turn limited by the shape of the gaps 17 and 18.

In the embodiment in accordance with FIG. 3 a low level of noise is also achieved in operation as the bearing outer ring 26 is not in direct metallic contact with the frame 37.

FIG. 4 shows an embodiment in which the spherical nut and the bearing outer ring are identical in construction to the embodiments in accordance with FIGS. 2 and 3. The bearing outer ring 26 also has a groove 31 on the circumferential side in which a damping element 32 lies.

In this embodiment, the frame is formed as a two-part housing in the region of the bearing shown. A first housing part 50 and a second housing part 51 are placed adjacently along a partition and attached with attachment means (not shown). The housing part 51 has a web 53 pointing radially inwards which forms the bearing seat as described above. The web 53 abuts the damping element 32. The housing parts 50 and 51 initially form a substantially cylindrical housing about the bearing outer ring 26, which cylindrical housing bears a ring collar pointing inwards on each of the housing parts 50 and 51 in a step from the bearing ring 26. The ring collar is shorter than the radial extension of the bearing outer ring 26 in a radial direction relative to the axis of symmetry. The two ring collars 54 and 55 form circular surfaces which extend parallel to the planar outer sides of the bearing outer ring 26. Plate springs lie on these circular surfaces, a first plate spring 56 and a second plate spring 57 on the ring collar 54. A third plate spring 58 and a fourth plate spring 59 are provided on a second ring collar 55. The plate springs 56 and 57 are arranged in mirror image. Their surfaces are therefore not parallel to one another but rather the plate springs 56 and 57 contact one another in a linear manner in the region of the largest diameter on the concave side. The concave sides of the plate springs 56 and 57 are facing one another. The convex sides are facing away from one anther. The plate spring 56 abuts in a linear manner the planar side of the ring collar 54 in the region of its shortest diameter. The plate spring 57 abuts in a linear manner the front face of the bearing outer ring 26 in the region of its shortest diameter. Accordingly, the plate springs 58 and 59 are also arranged in mirror image to one another. The lines of the shortest diameter abut the inner side of the flange 55 or the outer side of the bearing outer ring 26, while the two plate springs contact one another in a linear manner on their largest diameters. In this way, the bearing outer ring 26 is mounted in an elastic manner in an axial direction of the device between the plate springs. As in the other exemplary embodiments, the damping element 32 also slides on the inner side of the web 53 in an spring movement. If there are tilting movements, the bearing outer ring can press on one side against the plate spring 57 and against the plate spring 58 on the diametrically opposed side. The damping element 32 enables a corresponding tilting of the bearing outer ring 26. This embodiment is particularly robust and makes a minimal amount of noise due to the small contact surfaces in the region of the plate springs and the non metallic contact in the region of the damping element 32.

FIG. 5 is a perspective representation of a ring as it can be used as an damping element 32. The damping element 32 generally has a cylindrical, ring-shaped basic form, wherein the material strength is substantially constant over the entire circumference. Recesses 60 are provided at regular intervals from the narrow sides, which recesses are introduced in pairs directly adjacent to the opposing narrow sides. This forms a narrow, S-shaped web 61 between the recesses 60, which has a spring effect. This design means that the damping element 32 can be stretched such that its inner diameter increases. This means that the damping element 32 can be mounted on the bearing outer ring 26. Furthermore, in this way the damping element 32 is flexible such that it can be adapted to concrete dimensions in use between the bearing outer ring 26 and the adjacent web. In particular, the damping element 32 can also compensate for the different thermal expansion between the material of the bearing outer ring 26, which is generally steel, and the steering system housing or the frame, which is generally manufactured by aluminium casting. Under the influence of heat, the gap in which the damping element 32 is arranged increases. The damping element 32 is manufactured from plastics material with a higher coefficient of expansion and its thickness thereby increases to an extent corresponding to the increase in the size of the gap. The clearance of the bearing in the frame thereby remains substantially constant. The expansion of the damping element 32 itself in a circumference direction is compensated by the notches 60. The damping element 32 is preferably manufactured from a correspondingly loadable plastics material.

FIG. 6 shows an embodiment which is similar to FIG. 4. In these embodiments, the housing is also divided into two housing parts 62 and 63. As described above, four plate springs lie between the ring collars of the housing parts 62 and 63 and a bearing outer ring 65. The bearing outer ring 35 has no embedded damping element, but rather its outer side abuts an damping ring 66 which is inserted into the housing part 62 and surrounds the bearing outer ring 65 completely on its outer side. The damping element 66 is provided with a surface which is slightly convex in an inwards direction such that the bearing outer ring 65 abuts the damping element 66 in a substantially linear manner. The function is described similar to the embodiment in accordance with FIG. 4. The plate springs 64 enable a movement of the bearing outer ring 65 in an axial direction and a slight tilting. The tilting is facilitated by the shape of the damping element 66 such that when a deflection occurs in the steering rack mounted in the spherical nut 1 the bearing can follow this deflection without concerns being raised about overloading and therefore damage to the bearing.

Finally, FIG. 7 shows an embodiment which is similar to FIGS. 4 and 6 with plate springs 64 to provide axial support to the bearing outer ring 65. In this embodiment, the frame is composed of a first housing part 70 and a second housing part 71 in the region of the bearing shown. The two housing parts 70 and 71 are only shown schematically here. In a real embodiment, they are parts of a complex steering drive housing. The components 70 and 71 are substantially formed such that they surround the bearing outer ring 65 on the circumference side in the manner of a bearing seat and such that they form ring collars which point radially inwards which the plate springs 64 abut. These construction elements are described in greater detail in relation to FIG. 4.

The housing parts 70 and 71 are assembled such that the housing part 71 is provided with a sleeve-like region 72 which is connected opposite the outer circumference in a step 73 with a decreased circumference. Accordingly, the housing part 70 is increased in diameter inwards in a step 74. The sleeve-like region 72 fits into this region of the component 74. The length in the axial direction based on the longitudinal axis of the spherical nut 1 is selected in the sleeve-like region 72 such that when the components 70 and 71 are in abutment against one another between the distance 74 and the front face of the sleeve-like region 72 a free space remains which forms a peripheral groove 75. A damping element 76 is inserted into the peripheral groove 75. When completely assembled, the groove 75 surrounds the bearing outer ring 65 centrally along its outer circumferential surface. The damping element 76 abuts the outer circumferential surface of the bearing outer ring 65, while a peripheral annular clearance is provided between the housing parts 70 and 71 in the bearing outer ring 65.

In operation, if axial loads occur, and in particular with bending strain on the threaded spindle (not shown), the spherical nut 1 can be displaced by means of an spring movement against the plate springs 64. The bearing in the region of the outer circumferential surface through the damping element 76 also enables a pivoting of the bearing outer ring relative to the axis direction constructively provided for, such that even bending strains, as can occur in operation, do not lead to any damage to the ball circuit or the bearings of the spherical nut.

In this embodiment, the damping element 76 can be made from virtually any materials as it does not need to be stretched or compressed for the assembly. The damping element can be a ring in accordance with FIG. 5, the recesses 60 shown there are not necessarily required, however, in the embodiment in accordance with FIG. 7.

An advantage of the plate springs is that with two springs a progressive characteristic line of suspension can be achieved on each side of the bearing. A further advantage is that the plate springs themselves have a metallic stop on the end of the spring deflection. No additional stop is required.

### LIST OF REFERENCE

1. Spherical nut
2. Threaded spindle
3. Frame
4. Outer ring
5. Roller element
6. Running surface
7. Web
8. Protective element
9. Groove
10. Damping element
11. Support
12. Damping element
13. Groove
14. Damping element
15. Support
16. Damping element
17. Gap
18. Gap
20. Frame
21. Damping element
22. Support
23. Damping part
24. Groove
25. Collar
26. Bearing outer ring
28. Groove
29. Damping element
30. Web
31. Groove
32. Damping element
35. Damping element
36. Groove
37. Frame
38. Protective element
39. Groove
40. Damping element
41. Extension
42. Web
50. Housing part
51. Housing part
52. Partition
53. Web
54. Ring collar
55. Ring collar
56. Plate spring
57. Plate spring
58. Plate spring
59. Plate spring
60. Recess
61. Web
62. Housing part
63. Housing part
64. Plate spring
65. Bearing outer ring
66. Damping element
70. Housing part
71. Housing part
72. Sleeve-like region
73. Step
74. Step
75. Groove
76. Damping element

What is claimed is:

1. A power assisted steering system for a motor vehicle, comprising:
a servo motor;
a structural element, configured to be driven by the servo motor, and
a nut, which is rotatably mounted in a bearing in a frame that is part of a housing of the steering system, and which is configured to cause axial displacement of the structural element, wherein the nut engages with a threaded spindle formed on the structural element, wherein the nut is elastically supported in an axial direction by means of spring elements relative to the frame and supported on the frame in a radial direction along a narrow peripheral contact surface, and wherein the nut is tiltable in a radial direction with respect to the frame,
wherein the bearing is in abutment with the frame on an outer circumferential surface of an outer ring of the bearing by means of a web having a width less than a width of the outer circumferential surface of the outer ring of the bearing,
wherein the web is configured to enable tilting of the outer ring of the bearing in a radial direction with respect to the frame.

2. The power assisted steering system according to claim 1, wherein the web is formed as a plastics material element.

3. The power assisted steering system according to claim 15, wherein the plastics material element is placed in a groove formed on an outer circumferential surface of the bearing.

4. The power assisted steering system according to claim 15, wherein the plastics material element is configured to act as a damping element.

5. The power assisted steering system according to claim 1, wherein a peripheral web of the frame is manufactured from a non-metallic material which damps sound.

6. The power assisted steering system according to claim 1, wherein the web is inserted into a groove as an inserted part, wherein the groove pierces the circumferential surface of a bearing seat radially in an outwards direction.

7. The power assisted steering system according to claim 6, wherein the inserted part is shaped such that and manufactured from such a material that it compensates for different thermal expansions of the bearing outer ring and the frame.

8. The power assisted steering system according to claim 1, further comprising damping elements configured to axially support the nut, which damping elements are inserted or are incorporated into grooves provided in the frame, and which are disposed opposite respective faces, in an axial direction, of the outer ring of the bearing.

9. The power assisted steering system according to claim 1, wherein at least one of the spring elements is provided with elastomer properties by means of a shape-retaining element that lies in the bearing between the frame and a bearing outer ring outside of a force flux.

10. The power assisted steering system according to claim 9, wherein the shape-retaining element is manufactured from a plastics material.

11. The power assisted steering system according to claim 9, wherein the shape-retaining element is a concentric ring which is arranged on an inner side of the spring element.

12. The power assisted steering system according to claim 9, wherein the shape-retaining element is a concentric ring arranged on an outer side of the spring element.

13. The power assisted steering system according to claim 9, wherein the shape-retaining element is axially displaceable in the frame.

14. The power assisted steering system according to claim 1, wherein the web is convex.

15. The power assisted steering system according to claim 1, further comprising:
a plastics material element provided in a region of the web, wherein the plastics material element is arranged to prevent direct metallic contact between the bearing and the frame.

16. The power assisted steering system according to claim 1, wherein the web is disposed in a groove in the frame.

17. The power assisted steering system according to claim 1, wherein the spring elements are configured to prevent substantial axial displacement of the nut.
